(19) United States
(12) Patent Application Publication
(10) Pub. No.: US 2013/0328529 A1
(43) Pub. Date: Dec. 12, 2013

(54) SYSTEM AND METHOD FOR BALANCING MULTI-CELL BATTERY SYSTEMS

(71) Applicant: ALEXANDER DANILO ZBROZEK, SUNNYVALE, CA (US)

(72) Inventor: ALEXANDER DANILO ZBROZEK, SUNNYVALE, CA (US)

(21) Appl. No.: 13/494,832

(22) Filed: Jun. 12, 2012

(51) Int. Cl. H02J 7/00

(52) U.S. Cl. 320/118; 320/128

(57) ABSTRACT

A battery balancing system including two battery modules connected in series, wherein each module is coupled to a balancing circuit. The balancing circuit is selectively operable between two modes: a dissipative mode, wherein the balancing circuit is connected in parallel to the respective battery module and dissipates energy from the battery module as light; and a latent mode, wherein the balancing circuit is disconnected from the battery module. A method of balancing a battery, including: charging a module of the battery, the module including at least one electrochemical cell; monitoring a system parameter indicative of the module charge; determining that a dissipation condition has been met based on the system parameter; and connecting a balancing circuit to the module upon determination of the dissipation condition being met, wherein the balancing circuit dissipates energy from the battery module as light.

### TECHNICAL FIELD

This invention relates generally to the battery management field, and more specifically to a new and useful apparatus and method of battery balancing in the battery management field.

### BACKGROUND

Rechargeable, multi-cell systems have been used for decades to provide the desired voltage and power to a variety of applications. However, these systems all suffer from the problem of cell imbalance. Cell imbalance arises from the differences in individual cells' state of charge (SOC), self-discharge rate, capacity, impedance, and temperature characteristics, and occur even in battery cells of the same model from the same manufacturer, due to manufacturing variations. If unregulated, cell imbalances within a battery can result in cell overcharging and/or overheating, which, in turn, results in accelerated cell degradation and in some cases, fire or explosion.

Conventionally, battery balancing has been used to equalize voltage and SOC among the cells when they are at full charge. Battery balancing is typically categorized as two types: passive and active. Passive battery balancing discharges excess energy from high voltage cells through a dissipative bypass circuit. This bypass circuit is typically composed of one or more resistive components that bleed off the excess energy as heat. While this approach is substantially low-cost, it is undesirable for many applications as the generated heat results in thermal regulation issues, which, in turn, affects battery lifespan and operation. Active battery balancing typically employs inductive or capacitive elements to temporarily store and shuttle excess energy from cells with high voltage to cells with lower voltage. However, this approach costs substantially more than the passive battery balancing approach.

Thus, there is a need in the battery management field to create an new and useful apparatus and method of battery balancing.

### BRIEF DESCRIPTION OF THE FIGURES

FIGS. 1A and 1B are schematic representations of a battery balancing system in accordance with a preferred embodiment of the present invention in a dissipative mode and a latent mode, respectively.

FIG. 2 is a schematic representation of a first embodiment of the present invention.

FIG. 3 is a schematic representation of a second embodiment of the present invention.

FIG. 4 is a schematic representation of a first embodiment of the balancing circuit.

FIG. 5 is a schematic representation of a second embodiment of the balancing circuit.

FIG. 6 is a schematic representation of an embodiment of the present invention including a controller.

FIG. 7 is a schematic representation of an embodiment of the present invention including a light pipe.

FIGS. 8A and 8B are schematic representations of a method of balancing a battery.

FIGS. 9A and 9B are schematic representations of an embodiment of the method of balancing a battery.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

### 1. The Battery Balancing System.

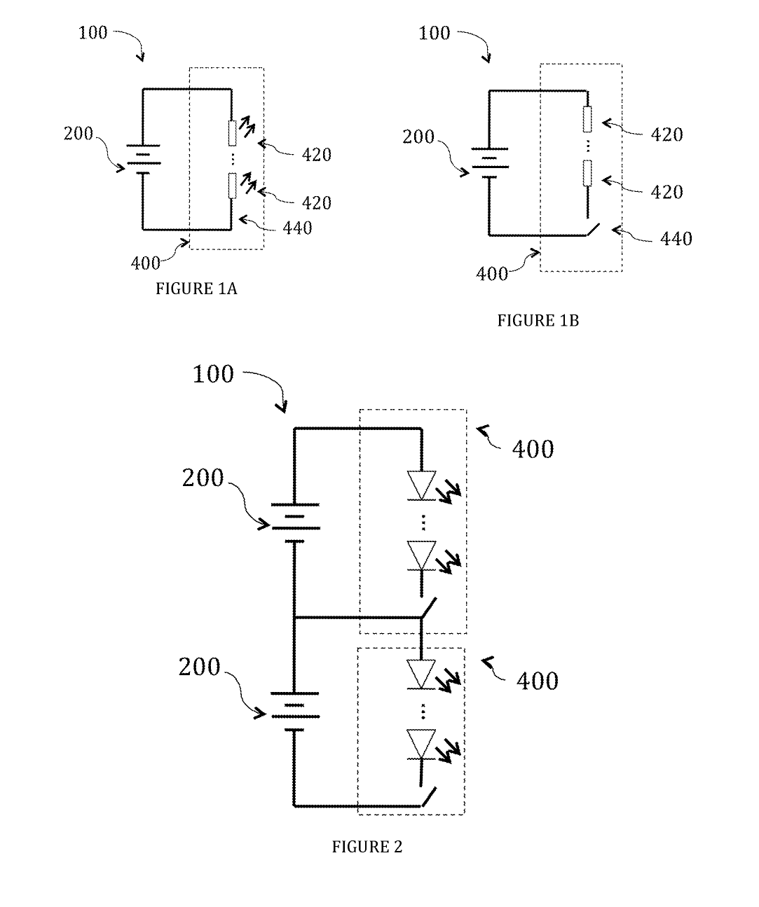

As shown in FIGS. 1A and 1B, the battery balancing system 100 of the preferred embodiments includes a battery module 200 coupled to a balancing circuit 400. More preferably, the battery balancing system 100 includes a plurality of battery modules 200, wherein each battery module 200 is associated with a balancing circuit 400. This system functions to equalize the charge of the battery modules 200 by dissipating excess energy as light, wherein the balancing circuits 400 are each selectively operable between: a dissipative mode, wherein the balancing circuit 400 is connected in parallel to the battery module 200 and dissipates energy from the battery module 200 as light (shown in FIG. 1A); and a latent mode, wherein the balancing circuit 400 is disconnected from the battery module 200 (shown in FIG. 1B). This system preferably balances the battery modules in a battery pack during pack charging, but can alternatively balance the battery modules during battery pack discharge. This system can have the advantage of extending the useful life of the battery pack by dynamically adjusting the voltage to which each module is charged over the module lifespan.

This battery balancing system 100 affords several advantages over the prior art. First, by selectively dissipating the excess energy from high voltage cells as light instead of heat, the need for battery thermal management can be greatly reduced, and the lifespan of the battery cells can be increased. Second, this system is distinguished over other passive systems, such as U.S. Application 2005/0,162,130, as the present embodiment allows the system to selectively bleed energy from each module 200. This allows the system to dynamically determine the voltage to which each module 200 will be charged (e.g. by bleeding off as much or as little energy as needed through the balancing circuit 400), and also to shut off energy dissipation when desired (e.g. when charging has stopped and discharging is desired). This is in contrast with the '130 reference, which will always limit the module voltage to the voltage across the balancing circuit terminals, and will constantly bleed off energy as long as the module terminal voltage is greater than the balancing circuit 400 terminal voltage, even when battery conservation is desired (e.g. during battery discharge to power a load).

The battery pack of the battery balancing system 100 functions to store energy. As shown in FIG. 2, the battery pack is preferably composed of multiple battery modules 200 (e.g. 1 . . . N modules 200) coupled together in series, but can alternatively be composed of multiple battery modules 200 coupled in parallel. Each battery module 200 preferably includes an electrochemical cell, and can include multiple cells, wherein the cells are preferably connected together in series but can alternatively be coupled together in parallel. The electrochemical cells of the battery pack are preferably rechargeable, and can be of any suitable chemistry. Battery chemistries can include lithium ion, lithium polymer, silver-zinc, and nickel-cadmium, although any suitable chemistry can be used. While the cells within a module 200 are preferably of the same chemistry, they can alternatively have different chemistries and ratings. Likewise, the modules 200 of the battery pack are preferably of the same chemistry, but cell chemistries and ratings can vary across different modules 200 of the rechargeable battery. The number and chemistry of cells and/or modules are preferably selected for a desired load or application, but can alternatively be selected for any other criteria.

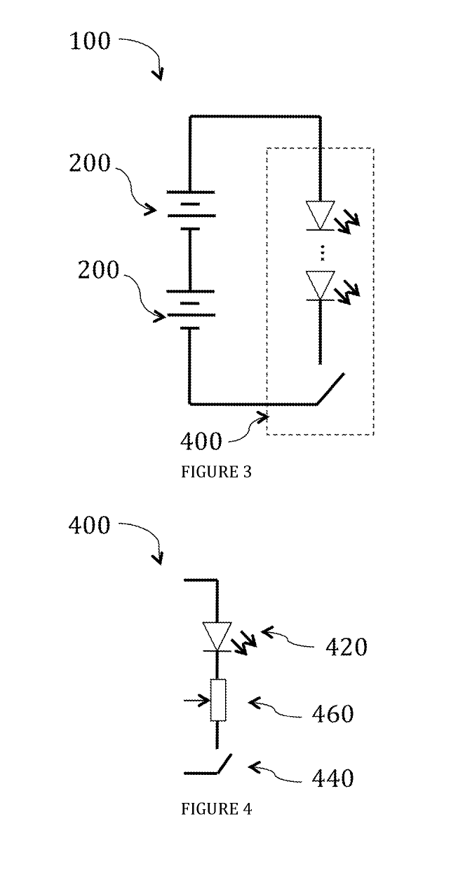

As shown in FIGS. 1A and 1B, the balancing circuit 400 of the battery balancing system 100 functions to dissipate excess energy as light. The balancing circuit 400 includes a light-emitting element 420 connected in series with a switch 440. More preferably, the balancing circuit 400 includes a switch 440 and a plurality of light-emitting elements 420. The balancing circuit 400 is preferably coupled in parallel with a module 200, wherein the terminals of the balancing circuit 400 are connected to the terminals of the module 200, but can be coupled in parallel with a cell. As shown in FIG. 2, the battery balancing system 100 preferably includes a balancing circuit 400 for each module 200, but can alternatively include one balancing circuit 400 for a group of modules 200 (shown in FIG. 3), multiple balancing circuits 400 for multiple modules 200, or have any other suitable configuration. The balancing circuit 400 is preferably connected (i.e. placed in dissipative mode) when energy dissipation is desired, such as when the module SOC is higher than or substantially close to the charge threshold. The balancing circuit 400 is preferably disconnected at all other times, including but not limited to module discharge and module charging (while still below the charge threshold). However, the balancing circuit 400 can alternatively be permanently connected to the module 200. The balancing circuit 400 and any associated circuitry is preferably located within the battery pack (e.g. within a battery casing), but can alternatively be located external the battery pack. Alternatively, the battery pack can only enclose the balancing circuit 400 or the associated circuitry.

As shown in FIGS. 1A and 1B, the light-emitting element(s) 420 of the balancing circuit 400 functions to dissipate excess energy as light when the balancing circuit 400 is connected to the module/cell. The light emitted by the light-emitting element 420 is preferably visible light, but can alternatively be infrared light, ultraviolet light, or any other suitable wavelength of light. While some heat can be generated during operation, the light-emitting element 420 preferably dissipates a majority of the excess energy as light, wherein only a small portion of the excess energy is dissipated as heat. The light-emitting element 420 is preferably operable over a wide range of voltages, but can alternatively be operable over a narrow range of voltages. While one type of light-emitting element 420 is preferably used, various types can be used in the same balancing circuit 400. The light-emitting element 420 is preferably a diode, such as a light emitting diode (LED, e.g. red, orange, amber, yellow, green, blue, white, etc.) or laser diode, but can be an incandescent light or any suitable light-emitting element. When a diode is used, a resistor 460 is preferably included in series with the diode to limit the current through the diode. The resistor 460 can have a substantially permanent resistivity, or can have a variable resistivity (e.g. a potentiometer) that can be controlled by the control system. The number, configuration, and voltage/current characteristics of light-emitting elements 420 included in each balancing circuit 400 are preferably selected based on the highest module voltage that can be achieved and the desired final battery voltage, but can be selected based on the desired power dissipation rate or any other suitable parameter.

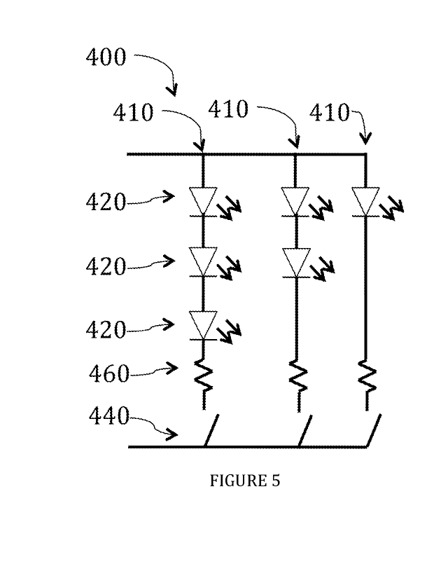

In one variation, the balancing circuit 400 includes an LED in series with one variable resistor 460 (e.g. potentiometer, shown in FIG. 4). Because the module voltage will typically be higher than the light-emitting element forward voltage, this circuit will always allow energy to be dissipated from the battery module 200, albeit slowly, as long as the resistor is adjusted to provide the adequate current through the light-emitting element 420. In a second variation, the balancing circuit 400 includes multiple LEDs coupled together in series, wherein the number of LEDs is selected such that the balancing circuit terminal voltage (BCTV) substantially matches the desired charge threshold (e.g. fully charged module voltage). For example, if the charge threshold is 8.5V, five red LEDs with a forward voltage drop of 1.7V each can be included in the balancing circuit 400. This variation can be advantageous, as the control system does not have to actively monitor the module voltage and disconnect the balancing circuit 400 when the charge threshold is reached (the balancing circuit 400 will shut off when the module voltage falls below the BCTV). In a third variation, the balancing circuit 400 includes multiple LEDs coupled together in parallel. In a fourth variation, shown in FIG. 5, the balancing circuit 400 includes multiple sub-balancing circuits 410 coupled together in parallel, wherein each sub-balancing circuit 410 includes multiple of light-emitting elements 420 coupled together in series with a switch 440. Depending on the desired module charge, a sub-circuit 410 can be selectively connected or disconnected from the module 200. For example, to discharge a circuit, a sub-circuit with a high BCTV can be connected until the module voltage falls below the first BCTV, wherein the first sub-circuit is disconnected and a second sub-circuit with a lower BCTV is connected. Thus, the module 200 can be gradually discharged without burning out the light-emitting element 420.

The switch 440 of the balancing circuit 400 functions to connect and disconnect the light-emitting elements 420 to and from the module/cell, and is operable between a connected mode and a disconnected mode. The switch 440 is preferably coupled in series with the light-emitting elements 420. The switch 440 is preferably an electronic switch, but can alternatively be a physical switch. The switch 440 is preferably a transistor, and can be an NPN or PNP bipolar junction transistor (BJT, such as an IGBT, avalanche transistor, etc.), an N-channel or P-channel field effect transistor (FET, such as a MOSFET, JFET, etc.), a junctionless nanowire transistors (JNT), or any other suitable electronic switch.

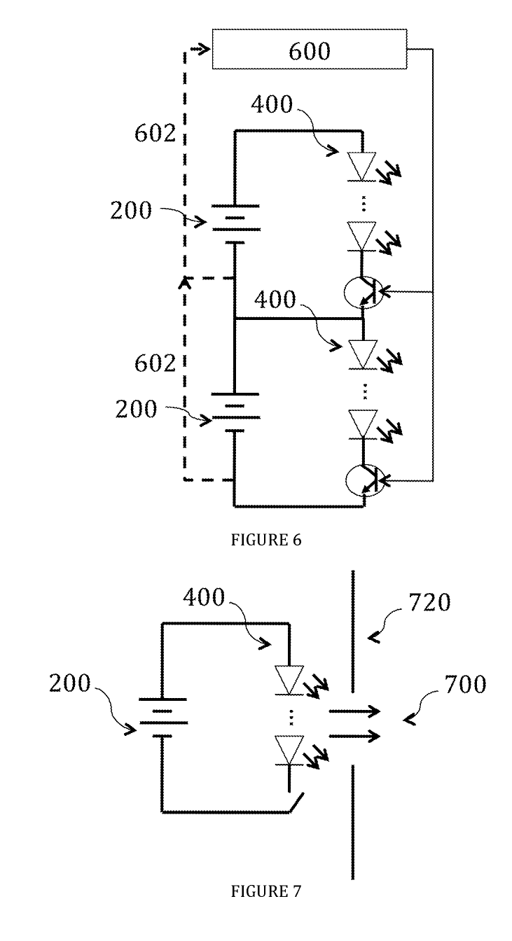

As shown in FIG. 6, the battery balancing system 100 can additionally include a controller 600 (or control system) that functions to control the switch position of each balancing circuit 400. The controller 600 preferably sends a signal to close the switch 440 (i.e. connect the module 200 and balancing circuit 400) when the module voltage is higher than or substantially near the desired voltage, and sends a signal to open the switch 440 (i.e. disconnect the module 200 from the balancing circuit 400) when the module voltage is lower than the desired voltage. The controller 600 can additionally facilitate module discharge. The controller 600 can also control the resistivity of the balancing circuit 400 resistor, wherein the resistor resistivity is adjusted based on the module voltage. The controller is preferably a PCB (printed circuit board), but can alternatively be any suitable control circuitry.

The controller 600 can additionally function to receive and process system parameter measurements 602. More specifically, the controller 600 preferably controls the switch position based on a comparison between a charge threshold and information indicative of the respective module charge. The charge threshold is preferably a preprogrammed voltage value, but can be determined from a chart (e.g. given the age, charge/discharge cycles, other module history, etc.), be determined empirically (e.g. determine the discharge rate when charged to a first voltage; adjust the desired voltage if the discharge rate is out of the desired range), or be determined in any suitable manner. Information indicative of module charge can be calculated from system parameter measurements, can be the system parameter measurement itself, or can be any other suitable information. Alternatively, the switch position can be controlled based on any suitable parameter. The information indicative of module charge is preferably the module voltage, but can alternatively be the amount of charge needed to achieve the desired voltage, the amount of time needed to achieve the desired voltage, or any other suitable information. The monitored system parameters preferably include module voltage and current, but can additionally/alternatively include time, temperature, resistivity, light, or any other suitable system parameter. The controller 600 preferably monitors the aforementioned system parameters for each module 200 within the battery pack, and controls each module 200 independently. Accordingly, the system, more preferably each module 200, preferably includes suitable sensors, such as timers, voltage, current, resistance, temperature, or light sensors, or any other suitable sensor.

Each module 200 can additionally include a sub-controller that functions to control the cells and/or cell balancing circuits 400 based on information indicative of the cell charge. Like the system controller, the module sub-controller can receive and process system parameter measurements (such as cell voltage, current, temperature, resistance, etc.) into information indicative of cell charge.

The battery balancing system 100 can additionally include a light pipe 700, which functions to remove the emitted light from the battery pack. A first end of the light pipe 700 is preferably positioned proximal the light emitting elements of the balancing circuit 400, while the second end of the light pipe 700 is preferably positioned substantially near the exterior of the battery pack. The battery balancing system 100 can additionally include light-concentrating elements, such as reflectors (mirrors), that assist in light dissipation and/or transport.

In a first variation, shown in FIG. 7, the battery pack includes a casing 720 with an optically transparent section (light pipe 700) that dissipates light to the battery pack exterior. The casing is preferably designed such that the optically transparent section is located substantially proximal the light-emitting elements 420, but can be designed such that it is located distal the light-emitting elements 420, wherein a second light pipe 700 transmits the emitted light to the optically transparent section. The optically transparent section is preferably a logo, pattern, or indicator (e.g. an indicator light), but can be a window or any other suitable configuration.

In a second variation, the light pipe 700 is an optical fiber that transmits the emitted light to a battery pack-battery charger interface, wherein the battery charger detects the transmitted light. The battery charger preferably ceases battery pack charging when the battery charger detects light emission from all the balancing circuits 400 of the battery pack (charging termination condition). The battery charger preferably includes one photodetector for each balancing circuit 400 of the battery pack, but can alternatively include a single photodetector, wherein the photodetector determines the charging termination condition based upon the lumens of emitted light.

### 2. Method of Battery Balancing.

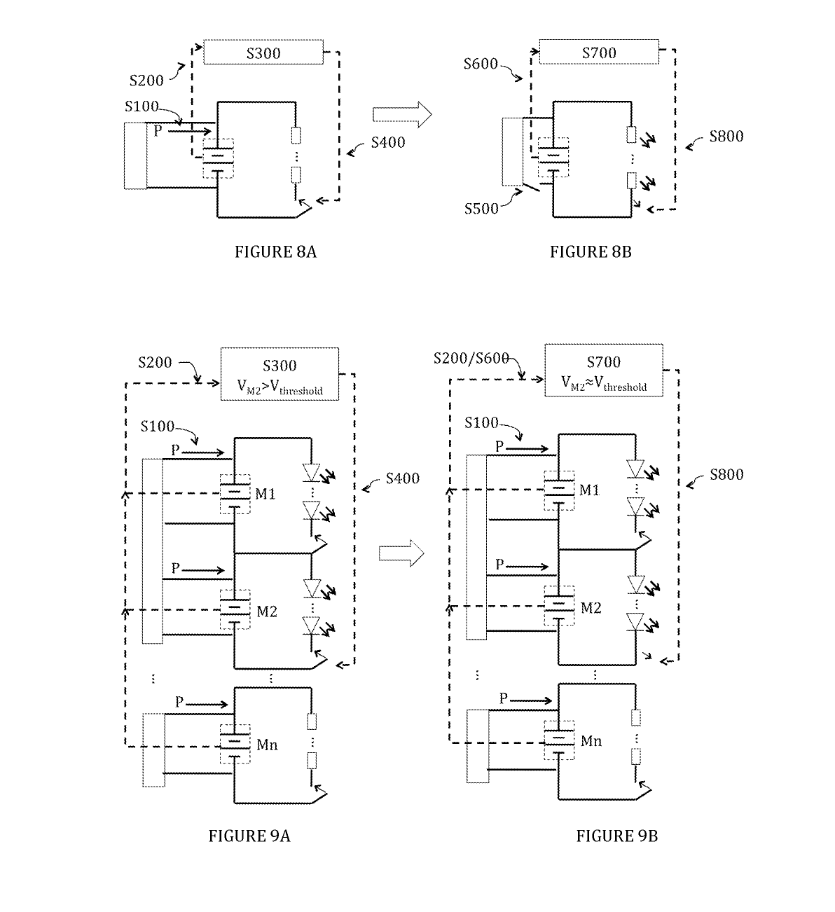

As shown in FIG. 8A, the method of balancing a battery includes charging a battery module S100, monitoring a system parameter indicative of module charge S200, determining that a dissipation condition has been met S300, and connecting a balancing circuit to the module, wherein the balancing circuit dissipates excess energy from the module as light S400. This method functions to balance a battery module by dissipating the excess energy as light. As shown in FIG. 8B, the method can additionally include the step of disconnecting the module from the battery charger S500. The method can additionally include monitoring the module while the balancing circuit is connected S600, determining that a disconnection condition has been met S700, and disconnecting the balancing circuit from the module S800. The method can additionally include determining a new charge threshold S900.

This method is preferably utilized with the battery balancing system 100 as described above, but can alternatively be utilized with any battery pack including multiple battery modules each coupled to a balancing circuit in parallel, wherein each battery module includes at least one battery cell and is coupled to the other modules in series. Each balancing circuit includes at least one light-emitting element (e.g. an LED) and a switch. A battery charger that includes an AC/DC or DC/DC conversion circuit preferably charges the battery modules, wherein the battery charger couples to the battery pack or battery module terminals.

Monitoring a system parameter indicative of module charge S200 functions to monitor the system for modules with excess charge. The system parameter is preferably monitored by a system controller coupled to a plurality of sensors. The system parameter is preferably monitored for each battery module, but can alternatively be monitored for a group of battery modules. The system parameter can be module voltage, current, temperature, resistance, charge duration, or any other suitable parameter. Accordingly, each module or group of modules being monitored preferably includes a voltage sensor, current sensor, temperature sensor, resistance sensor, timer, or any other suitable sensor.

Determining that a dissipation condition has been met S300 functions to identify modules with excess charge. The dissipation condition is preferably met when the substantially instantaneous module voltage and/or state of charge (SOC) exceeds the charge threshold and/or desired SOC (e.g. module overcharging), but can be met when the substantially instantaneous module voltage/SOC is substantially close to the charge threshold/SOC (e.g. is within 90-95% of the charge threshold). The substantially instantaneous module voltage/SOC is preferably determined from a measured system parameter. In a first variation, the instantaneous module voltage/SOC is the measured module voltage. In a second variation, the instantaneous module voltage/SOC is calculated from the module current and the module resistance. In a third variation, the instantaneous module voltage/SOC is calculated from the heat generated by the charging module. However, the dissipation condition can be met when a predetermined charging time is met (e.g. the system determines the initial module charge, the desired module charge, and the amount of time needed to charge the module to the desired module charge). The dissipation condition can alternatively be met when the module has been charged the predetermined charging amount. The predetermined charging amount is preferably calculated as the difference between the initial module charge and the desired module charge, and the amount the module has been charged is preferably determined from the amount of power adsorbed by the module (e.g. from the module resistance and current flow into the module). However, the dissipation condition can alternatively be any suitable condition indicative of a need for excess module energy dissipation. The charge threshold/SOC is preferably a predetermined (e.g. preprogrammed) voltage/SOC threshold, but can alternatively be selected from a chart (e.g. based on the number of module charge/discharge cycles, discharge rate, charge rate, or any other historical parameter), determined dynamically (e.g. wherein the charge threshold/SOC is lowered if the discharge or charge rate is too high for a given module), or determined in any suitable manner.

Connecting a balancing circuit to the module S400 functions to dissipate the excess module energy as light. This step is preferably performed by the switch of the balancing circuit, wherein a system controller preferably controls the switch position. This is preferably performed in response to the determination of a dissipation condition being met.

The method can additionally include disconnecting the module from the battery charger S500, which functions to cease energy input into the overcharged module. Charger disconnection is preferably performed substantially simultaneously with balancing circuit connection, particularly when the disconnection condition is module overcharging. However, charger disconnection after balancing circuit connection can be preferred when the disconnection condition is met when the module voltage/SOC nears the charge threshold/SOC. Charger disconnection preferably only includes cessation of power provision to the battery module, and does not include physical disconnection of the battery module from the battery charger. However, power provision to the battery module can otherwise be ceased (e.g. through physical disconnection of the battery module from the charger). Alternatively, the charger can not be disconnected until all the modules of the battery pack have reached the respective desired charge state, wherein the balancing circuits of the fully charged modules continuously dissipate the excess energy fed into the modules.

The method can additionally include monitoring the module while the balancing circuit is connected S600, which functions to determine when a module has been discharged to the desired charge. This step is preferably performed in substantially the same manner as S200, wherein system parameters are monitored to determine the module charge/discharge state. In a first variation, the amount of module charge is monitored by measuring the module voltage/SOC. In a second variation, the amount of module discharge is monitored by measuring an initial module voltage/SOC and measuring a second module voltage/SOC, wherein the module discharge amount is the difference between the two. In a third variation, the module discharge is monitored by a timer, wherein the system determines the amount that the module should be discharged (e.g. based off the initial module voltage/SOC and the charge threshold/SOC) and calculates the amount of time the balancing circuit needs to be connected (based off the balancing circuit discharge rate).

The method can additionally include determining that a disconnection condition has been met S700, which functions to identify modules that have reached the charge threshold. In a first variation, the disconnection condition is preferably met when the module voltage falls to the charge threshold/SOC, or can be met when the module voltage/SOC falls within a range of the charge threshold/SOC (e.g. between 95% and 105% of the charge threshold). In a second variation, the disconnection condition is met when the duration of module discharge (e.g. the amount of time the balancing circuit has been connected to the module) meets a predetermined time. This predetermined time is preferably calculated from the initial module voltage/SOC, the charge threshold/SOC, and the known dissipation rate of the balancing circuit. In a third variation, the disconnection condition is met when the amount of module discharge meets a predetermined discharge threshold. The threshold is preferably calculated as the difference between the initial module voltage/SOC and the charge threshold/SOC. The amount of module discharge can be calculated (e.g. from the known balancing circuit dissipation rate and the duration of balancing circuit connection), can be measured (e.g. by measuring and recording the current through the balancing circuit), or can be determined in any other suitable manner.

The method can additionally include disconnecting the balancing circuit from the module S800, which functions to end energy dissipation from the module. Balancing circuit disconnection is preferably performed after determination of a disconnection condition being met. Balancing circuit disconnection is preferably accomplished by placing the switch of the balancing circuit in an open configuration, and is preferably controlled by the system controller. Alternatively, balancing circuit disconnection can be accomplished by physical removal of the battery charger, wherein the balancing circuit is a portion of the battery charger.

The method can additionally include the step of determining a new charge threshold S900, which functions to adjust the desired state of charge to which a given module is charged. A new charge threshold is preferably determined when a trigger event is met. The trigger event is preferably indicative of a decrease in battery module performance. The trigger event can be dependent on module temperature, discharge rate, charge rate, module resistivity, or any other module parameter. For example, the trigger event can be an increased module temperature during or after charging (e.g. over a predetermined temperature threshold), an increased discharge rate (e.g. beyond a threshold discharge rate), a decreased charge rate (e.g. beyond a threshold charge rate), or higher resistivity. However, any other events indicative of the overall battery quality can serve as the trigger event. The charge threshold is preferably decreased in response to detection of a trigger event, such that the lifespan of the battery module can be extended (e.g. prevent overcharging). However, the charge threshold can be increased to compensate for the decrease in battery performance. The modified charge threshold is preferably determined from a chart (e.g. based on the module age, rating, discharge/charge rate, or any other suitable parameter), but can be predetermined (e.g. the charge threshold is adjusted a predetermined amount) or can be empirical, wherein the charge threshold is continuously adjusted until the trigger event is no longer detected. The modified charge threshold is preferably determined by the system controller, but can alternatively be determined by the module controller, the charger controller, an external controller, or any other suitable means.

### 3. Examples of the Method.

As shown in FIGS. 9A and 9B, a first example of the battery balancing method includes: charging a plurality of battery modules S100; monitoring the SOC of each module by taking periodic SOC measurements S200; determining that the substantially instantaneous SOC of a module is greater than the charge threshold S300; connecting a balancing circuit to said module S400 (as shown in FIG. 9A); monitoring the module while the balancing circuit is connected S600; and disconnecting the balancing circuit from the module when the module charge is within a given range of the charge threshold (e.g. within 95-105% of the charge threshold) S800 (as shown in FIG. 9B). The method further includes monitoring the module temperature, wherein the charge threshold is adjusted if the module temperature exceeds a predetermined temperature threshold during charging.

In a second example of the battery balancing method, the method includes: charging a plurality of battery modules, determining the amount of charge each module requires to meet the charge threshold (dissipation condition); monitoring the amount each module is charged (e.g. by monitoring the power transfer, current, etc.); and connecting the balancing circuit, wherein the balancing circuit is configured to dissipate power from the module until the charge threshold is met (e.g. if the charge threshold is 7V, then the balancing circuit includes the suitable number of LEDs).

As a person skilled in the art will recognize from the previous detailed description and from the figures and claims, modifications and changes can be made to the preferred embodiments of the invention without departing from the scope of this invention defined in the following claims.

I claim:

1. A rechargeable battery comprising:
two battery modules connected in series, each battery module comprising at least one electrochemical cell;
two balancing circuits, each coupled to a battery module, each selectively operable between:
a dissipative mode, wherein the balancing circuit is connected in parallel to the respective battery module and dissipates energy from the battery module as light; and,
a latent mode, wherein the balancing circuit is disconnected from the battery module.

2. The battery of claim 1, wherein each balancing circuit comprises a diode coupled in series with a switch.

3. The battery of claim 1, wherein the balancing circuit comprises a switch and a plurality of diodes coupled in series.

4. The battery of claim 3, wherein the diode is a light emitting diode.

5. The battery of claim 1, wherein the battery further comprises a controller configured to switch the balancing circuit between the dissipative mode and the latent mode.

6. The battery of claim 1, wherein the battery further comprises a light pipe optically coupled to the balancing circuit.

7. The battery of claim 6, wherein the battery further comprises a cover with an optically transparent segment, wherein the optically transparent segment is the light pipe.

8. The battery of claim 6, wherein the light pipe is configured to transport the light to an indicator symbol.

9. A method of balancing a battery, comprising:
charging a module of the battery, the module comprising at least one electrochemical cell;
monitoring a system parameter indicative of the module charge;
determining that a dissipation condition has been met based on the system parameter; and
connecting a balancing circuit to the module upon determination of the dissipation condition being met, wherein the balancing circuit dissipates energy from the battery module as visible light.

10. The method of claim 9, wherein the balancing circuit comprises a diode, wherein the balancing circuit is coupled to the cell with a switch.

11. The method of claim 9, wherein determining that the dissipation condition has been met comprises determining the module has been charged to a predetermined charge threshold for the module.

12. The method of claim 11, wherein the charge threshold for each module is determined empirically.

13. The method of claim 9, wherein monitoring a module comprises determining the module state of charge.

14. The method of claim 9, further comprising disconnecting the balancing circuit from the module upon determination of a disconnection condition being met.

15. The method of claim 14, wherein the disconnection condition is met when the measured module charge falls below the maximum charge.
